(19) United States
(12) Patent Application Publication
(10) Pub. No.: US 2014/0279616 A1
(43) Pub. Date: Sep. 18, 2014

(54) SYSTEM AND METHOD OF UTILIZING INFORMATION FROM A SOCIAL MEDIA SERVICE IN AN ECOMMERCE SERVICE

(71) Applicants: Debora E. Aoki, Oakland, CA (US); Kay Daughney, San Jose, CA (US); Lanny Mirawati, San Jose, CA (US)

(72) Inventors: Debora E. Aoki, Oakland, CA (US); Kay Daughney, San Jose, CA (US); Lanny Mirawati, San Jose, CA (US)

(73) Assignee: eBay Inc., San Jose, CA (US)

(21) Appl. No.: 13/829,326

(22) Filed: Mar. 14, 2013

(51) Int. Cl. G06Q 30/02; G06Q 50/00

(52) U.S. Cl. CPC G06Q 30/0282; G06Q 50/01
USPC 705/319

(57) ABSTRACT

A system and method of utilizing information from a social media service in an ecommerce system are provided. Log-in information for a social media service of a user of an ecommerce service may be received. Then, information may be retrieved from the social media service using the log-in information. This information can then be used to alter a reputation rating for a user in the ecommerce system or to form a trading circle with other users of the ecommerce system.

### BACKGROUND

Advancements in computer and networking technology enable users and entities to conduct various types of online activities via computer-based applications and systems. These online activities may include offering items for purchase through listings in a network-based marketplace. Buyers and sellers, however, may be concerned about the risks of conducting transactions with unknown and/or anonymous parties. A reputation system can be utilized to help alleviate these concerns. Traditionally, such a system involves feedback from previous transactions being used to calculating a reputation rating for a party in the online marketplace. Newer users, however, may not have engaged in enough transactions for a proper rating and other users may be unwilling to engage in transactions until a good reputation rating is established, thereby creating a vicious circle where new users are unable to engage in the very transactions they need in order to build a good reputation.

### BRIEF DESCRIPTION OF DRAWINGS

FIG. 1 is a network diagram depicting a network system, according to one embodiment, having a client-server architecture configured for exchanging data over a network.

FIG. 2 is a block diagram illustrating a network environment, according to some embodiments.

FIG. 3 is an example block diagram illustrating multiple components that, in one example embodiment, are provided within a publication system of a networked system.

FIG. 4 is a block diagram illustrating a data-mining module, according to some embodiments.

FIG. 5 is a block diagram illustrating social applications that execute on a social networking server, such as one located on a third-party platform, according to an example embodiment.

FIG. 6 is a block diagram illustrating a database, according to an embodiment, at the social networking server.

FIG. 7 is a block diagram illustrating a system, in accordance with an example embodiment, of utilizing information from a social media service in an ecommerce service.

FIG. 8 is a block diagram illustrating a system, in accordance with an example embodiment, of utilizing information from a social media service in an ecommerce service.

FIG. 9 is a flow diagram illustrating a method, in accordance with another example embodiment.

FIG. 10 is a flow diagram illustrating a method, in accordance with another example embodiment.

FIG. 11 shows a diagrammatic representation of a machine in the example form of a computer system within which a set of instructions for causing the machine to perform any one or more of the methodologies discussed herein may be executed.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments. It will be evident, however, to those skilled in the art that embodiments may be practiced without these specific details. In general, well-known instruction instances, protocols, structures, and techniques have not been shown in detail.

Although the present embodiments have been described with reference to specific example embodiments, it will be evident that various modifications and changes may be made to these embodiments without departing from the broader spirit and scope of the embodiments. Accordingly, the specification and drawings are to be regarded in an illustrative rather than a restrictive sense.

In an example embodiment, information from social media services (such as Facebook™ or Twitter™) can be used by an ecommerce service (such as eBay™ or PayPal™) to enhance reputation ratings and/or create online trading communities based on interest. The information utilized from social media services for these purposes could be any information that may be helpful in determining a reputation rating or creating an online trading community. In an example embodiment, information from a user profile, such as interest information, number of friends or contacts, mutual contacts, etc. can be used. In another example embodiment, communications from within the social media services may be monitored for information that may be helpful for these purposes. In an example embodiment, users of an ecommerce service may provide login information (e.g., username and password) for the social media services to the ecommerce service and the ecommerce service may link this login information to a user's ecommerce service account. In this manner, the ecommerce service may obtain or otherwise derive the information without needing additional user intervention.

FIG. 1 is a network diagram depicting a network system 100, according to one embodiment, having a client-server architecture configured for exchanging data over a network. For example, the network system 100 may include a network-based publisher 102 where clients may communicate and exchange data within the network system 100. The data may pertain to various functions (e.g., online item purchases) and aspects (e.g., managing content) associated with the network system 100 and its users. Although illustrated herein as a client-server architecture as an example, other embodiments may include other network architectures, such as a peer-to-peer or distributed network environment.

A data exchange platform, in an example form of a network-based publisher 102, may provide server-side functionality, via a network 104 (e.g., the Internet, wireless network, cellular network, or a Wide Area Network (WAN)) to one or more clients. The one or more clients may include users that utilize the network system 100 and more specifically, the network-based publisher 102, to exchange data over the network 104. These transactions may include transmitting, receiving (communicating) and processing data to, from, and regarding content and users of the network system 100. The data may include, but are not limited to, content and user data such as feedback data; user profiles; user attributes; product attributes; product and service reviews; product, service, manufacturer, and vendor recommendations and identifiers; social network commentary; product and service listings associated with buyers and sellers; auction bids; and transaction data, among other things.

In various embodiments, the data exchanges within the network system 100 may be dependent upon user-selected functions available through one or more client or user interfaces (UIs). The UIs may be associated with a client device, such as a client device 110 using a web client 106. The web client 106 may be in communication with the network-based publisher 102 via a web server 116. The UIs may also be associated with a client device 112 using a programmatic client 108, such as a client application. It can be appreciated that in various embodiments the client devices 110, 112 may be associated with a buyer, a seller, a third party electronic commerce platform, a payment service provider, or a shipping service provider, each in communication with the network-based publisher 102 and optionally each other. The buyers and sellers may be any one of individuals, merchants, or service providers, among other things. The client devices 110 and 112 may comprise a mobile phone, desktop computer, laptop, or any other communication device that a user may use to access the network-based publisher 102.

Turning specifically to the network-based publisher 102, an application program interface (API) server 114 and a web server 116 are coupled to, and provide programmatic and web interfaces respectively to, one or more application servers 118. The application servers 118 host one or more publication systems(s) 120 and one or more payment systems 122. The application servers 118 are, in turn, shown to be coupled to one or more database server(s) 124 that facilitate access to one or more database(s) 126.

In one embodiment, the web server 116 and the API server 114 communicate and receive data pertaining to products, listings, transactions, social network commentary and feedback, among other things, via various user input tools. For example, the web server 116 may send and receive data to and from a toolbar or webpage on a browser application (e.g., web client 106) operating on a client device (e.g., client device 110). The API server 114 may send and receive data to and from an application (e.g., programmatic client 108) running on another client device (e.g., client device 112).

The publication system 120 publishes content on a network (e.g., the Internet). As such, the publication system 120 provides a number of publication and marketplace functions and services to users that access the network-based publisher 102. For example, the publication system(s) 120 may provide a number of services and functions to users for listing goods and/or services for sale, facilitating transactions, and reviewing and providing feedback about transactions and associated users. Additionally, the publication system(s) 120 may track and store data and metadata relating to products, listings, transactions, and user interaction with the network-based publisher 102. The publication system(s) 120 may aggregate the tracked data and metadata to perform data mining to identify trends or patterns in the data. The publication system 120 is discussed in more detail in connection with FIG. 3. While the publication system 120 is discussed in terms of a marketplace environment, it is noted that the publication system 120 may be associated with a non-marketplace environment.

The payment system 122 provides a number of payment services and functions to users. The payment system 122 allows users to accumulate value (e.g., in a commercial currency, such as the U.S. dollar, or a proprietary currency, such as “points”) in accounts, and then later to redeem the accumulated value for products (e.g., goods or services) that are made available via the publication system 120. The payment system 122 also facilitates payments from a payment mechanism (e.g., a bank account, PayPal account, or credit card) for purchases of items via the network-based marketplace. While the publication system 120 and the payment system 122 are shown in FIG. 1 to both form part of the network-based publisher 102, it will be appreciated that, in alternative embodiments, the payment system 122 may form part of a payment service that is separate and distinct from the network-based publisher 102.

FIG. 2 is a block diagram illustrating a network environment 200, according to some embodiments. Referring to FIG. 2, a client device 110 executing a web client 106 and a client device 112 executing a programmatic client 108 may communicate with a network-based publisher 102, as described with respect to FIG. 1, or a third-party platform 204 via the network 104. In some embodiments, the third-party platform 204 may be a social networking platform, a gaming platform, or another network-based publisher platform. In some embodiments, the network-based publisher 102 may publish content or applications (e.g., games, social networking applications) on the third-party platform 204 either directly or via the network 104. As client devices 110, 112 interact with third-party platform 204, the network-based publisher 102 may receive data pertaining to the interactions. The data may be received through the use of API calls to open a connection or transmit data between the network-based publisher 102 and the third-party platform 204.

Referring now to FIG. 3, an example block diagram illustrating multiple components that, in one example embodiment, are provided within the publication system 120 of the network-based publisher 102 (see FIG. 1), is shown. The publication system 120 may be hosted on dedicated or shared server machines (not shown) that are communicatively coupled to enable communications between the server machines. The multiple components themselves are communicatively coupled (e.g., via appropriate interfaces), either directly or indirectly, to each other and to various data sources, to allow information to be passed between the components or to allow the components to share and access common data. Furthermore, the components may access the one or more database(s) 126 via the one or more database servers 124, both shown in FIG. 1.

In one embodiment, the publication system 120 provides a number of publishing, listing, and price-setting mechanisms whereby a seller may list (or publish information concerning) goods or services for sale, a buyer can express interest in or indicate a desire to purchase such goods or services, and a price can be set for a transaction pertaining to the goods or services. To this end, the publication system 120 may comprise at least one publication engine 302 and one or more auction engines 304 that support auction-format listing and price setting mechanisms (e.g., English, Dutch, Chinese, Double, reverse auctions, etc.). The various auction engines 304 also provide a number of features in support of these auction-format listings, such as a reserve price feature whereby a seller may specify a reserve price in connection with a listing, and a proxy-bidding feature whereby a bidder may invoke automated proxy bidding.

A pricing engine 306 supports various price listing formats. One such format is a fixed-price listing format (e.g., the traditional classified advertisement-type listing or a catalog listing). Another format comprises a buyout-type listing. Buyout-type listings (e.g., the Buy-It-Now (BIN) technology developed by eBay Inc., of San Jose, Calif.) may be offered in conjunction with auction-format listings and may allow a buyer to purchase goods or services, which are also being offered for sale via an auction, for a fixed price that is typically higher than a starting price of an auction for an item.

A store engine 308 allows a seller to group listings within a “virtual” store, which may be branded and otherwise personalized by and for the seller. Such a virtual store may also offer promotions, incentives, and features that are specific and personalized to the seller. In one example, the seller may offer a plurality of items as Buy-It-Now items in the virtual store, offer a plurality of items for auction, or a combination of both.

A reputation engine 310 allows users that transact, utilizing the network-based publisher 102, to establish, build, and maintain reputations. These reputations may be made available and published to potential trading partners. Because the publication system 120 supports person-to-person trading between unknown entities, users may otherwise have no history or other reference information whereby the trustworthiness and credibility of potential trading partners may be assessed. For example, the reputation engine 310 allows a user, through feedback provided by one or more other transaction partners, to establish a reputation within the network-based publication system 120 over time. Other potential trading partners may then reference the reputation for purposes of assessing credibility and trustworthiness.

Navigation of the network-based publication system 120 may be facilitated by a navigation module 312. For example, a search engine (not shown) of the navigation module 312 enables keyword searches of listings published via the publication system 120. In a further example, a browse engine (not shown) of the navigation module 312 allows users to browse various categories, catalogs, or inventory data structures according to which listings may be classified within the publication system 120. The search engine and the browse engine may provide retrieved search results or browsed listings to a client device 110,112. Various other navigation applications within the navigation engine 312 may be provided to supplement the searching and browsing applications.

In order to make listings available via the network-based publisher 102 as visually informing and attractive as possible, the publication system 120 may include a data mining engine 314 that enables users to upload images for inclusion within listings and to incorporate images within viewed listings. The data mining engine 314 also receives social data from a user and utilizes the social data to identify an item depicted or described by the social data.

An API engine 316 stores API information for various third-party platforms 204 and interfaces. For example, the API engine 316 may store API calls used to interface with a third-party platform 204. In the event a publication system(s) 120 is to contact a third-party application or platform 204, the API engine 316 may provide the appropriate API call to use to initiate contact. In some embodiments, the API engine 316 may receive parameters to be used for a call to a third-party application or platform 204 and may generate the proper API call to initiate the contact.

A listing creation and management engine 318 (which could be a separate creation engine and a separate management engine) allows sellers to create and manage listings. Specifically, where a particular seller has authored or published a large number of listings, the management of such listings may present a challenge. The listing creation and management engine 318 provides a number of features (e.g., auto-relisting, inventory level monitors, etc.) to assist the seller in managing such listings.

A post-listing management engine 320 also assists sellers with a number of activities that typically occur post-listing. For example, upon completion of an auction facilitated by the one or more auction engines 304, a seller may wish to leave feedback regarding a particular buyer. To this end, the post-listing management engine 320 provides an interface to the reputation engine 310 allowing the seller to conveniently provide feedback regarding multiple buyers to the reputation engine 310.

A messaging engine 322 is responsible for the generation and delivery of messages to users of the network-based publisher 102. Such messages include, for example, advising users regarding the status of listings and best offers (e.g., providing an acceptance notice to a buyer who made a best offer to a seller). The messaging engine 322 may utilize any one of a number of message delivery networks and platforms to deliver messages to users. For example, the messaging engine 322 may deliver electronic mail (e-mail), an instant message (IM), a Short Message Service (SMS), text, facsimile, or voice (e.g., Voice over IP (VoIP)) messages via wired networks (e.g., the Internet), a Plain Old Telephone Service (POTS) network, or wireless networks (e.g., mobile, cellular, Wi-Fi, WiMAX).

A data-mining engine 324 analyzes the data gathered by the network-based publisher 102 from interactions between the client devices 110, 112 and the network-based publisher 102. In some embodiments, the data mining engine 324 also analyzes the data gathered by the network based publisher 102 from interactions between components of the network-based publisher 102 and/or client devices 110, 112 and third-party platforms 204, such as social networks like Twitter™, and also publications, such as eBay and Amazon. The data-mining engine 324 uses the data to identify certain trends or patterns in the data. For example, the data-mining engine 324 may identify patterns, which may help to improve search query processing, user profiling, and identification of relevant search results, among other things.

A taxonomy engine (not pictured) uses the patterns and trends identified by the data mining engine 324 to obtain a variety of data, including products, item listings, search queries, keywords, search results, and individual attributes of items, users, or products, among other things, and revise the publication system 120 taxonomy as discussed below. In some embodiments, the taxonomy engine 326 may assign a score to each piece of data based on the frequency of occurrence of the piece of data in the mined set of data. In some embodiments, the taxonomy engine 326 may assign or adjust a score of a piece of data pertaining to an item (e.g., one or more keywords with logic, a product listing, an individual attribute of the item) based on input data received from users. The score may represent a relevance of the piece of data to the item or an aspect of the item. In some embodiments, the taxonomy engine 326 may compare data received from the third party platform 204 to previously received and stored data from the third party platform 204. Alternatively, the taxonomy engine may compare data received from the third party platform 204 with data in the publication system's 120 own taxonomy.

Although the various components of the publication system 120 have been defined in terms of a variety of individual modules, a skilled artisan will recognize that many of the items can be combined or organized in other ways. Furthermore, not all components of the publication system 120 have been included in FIG. 3. In general, components, protocols, structures, and techniques not directly related to functions of example embodiments (e.g., dispute resolution engine, loyalty promotion engine, personalization engines, etc.) have not been shown or discussed in detail. The description given herein simply provides a variety of example embodiments to aid the reader in an understanding of the systems and methods used herein.

FIG. 4 is a block diagram illustrating the data-mining engine 324, according to some embodiments. Information may be mined from social media websites and communications, such as from Facebook™ and Twitter™ feeds. Referring to FIG. 4, an interface module 402 may store components used to interface with a third party platform such as 204 of FIG. 2 from which data is mined. The third party platform 204 could be from eBay and/or Amazon, or from a social network such as Twitter™. Interfacing with third party platforms 204 may entail providing data related to items about which searches or opinions from users of the third party platform 204 are solicited. The user input may include search keywords, descriptions, opinions, or other text, along with non-textual input, such as clicks, highlighting, and other interactions with the provided item text and visual data.

A collection module 404 collects the data mined from the third party platform 204. For mining Twitter™, tweets and retweets of a particular search may be included. In some embodiments the publication system 120 may also store Twitter™ IDs, their bio, location, how many followers, their following, and similar information that may be publically available from the social network. In some embodiments, the collection module 404 interfaces with the third party platform 204 directly and collects data entered by the user. In some embodiments, the collection module 404 collects the data from the interface module 402.

A database module 406 interfaces with one or more databases such as the database 126 of FIG. 1 to store the data collected by the collection module 404. The database module 406 also interfaces with the one or more databases 126 to retrieve data related to the items presented in the third party platform 204. For example, the database module 406 may retrieve searches related to a certain product and provide the searches to the third party platform 204 for purposes of comparing a user's search to previously stored searches. Based on the comparison, the interface module 402 or the taxonomy engine 326 may revise the publication system's 120 taxonomy.

FIG. 5 is a block diagram illustrating social platform applications 500 that execute on a social networking server, such as one located on a third-party platform 204 of FIG. 2, according to an example embodiment. The social platform applications 500 include news feed applications 502, profile applications 504, note applications 506, forum applications 508, search applications 510, relationship applications 512, network applications 514, communication applications 516, account applications 518, photo applications 520, event applications 522, and group applications 524.

The news feed applications 502 publish events associated with the user and friends of the user on the social networking server. The news feed applications 502 may publish the events on the user profile of a user. For example, the news feed applications 502 may publish the uploading of a photo album by one user on the user profile of the user and the user profiles of friends of the user.

The profile applications 504 may maintain user profiles for each of the users on the social networking server. Further, the profile applications 504 may enable a user to restrict access to selected parts of their profile to prevent viewing by other users. The note applications 506 may be used to author notes that may be published on various user interfaces.

The forum applications 508 may maintain a forum in which users may post comments and display the forum via the profile associated with a user. The user may add comments to the forum, remove comments from the forum, and restrict visibility to other users. In addition, other users may post comments to the forum.

The search applications 510 may enable a user to perform a keyword search for users, groups, and events. In addition, the search applications 510 may enable a user to search for content (e.g., favorite movies) on profiles accessible to the user.

The relationship applications 512 may maintain relationship information for the users. The network applications 514 may facilitate the addition of social networks by a user, with the social networks based on a school, workplace, or region, or any social construct for which the user may prove an affiliation. The communication applications 516 may process incoming and outgoing messages, maintain an inbox for each user, facilitate sharing of content, facilitate interaction among friends (e.g., poking), process requests, process events, process group invitations, and process communication notifications.

The account applications 518 may provide services to facilitate registering, updating, and deleting user accounts. The photo applications 520 may provide services to upload photographs, arrange photographs, set privacy options for albums, and tag photographs with text strings. The event applications 522 may provide services to create events, review upcoming events, and review past events. The group applications 524 may be used to maintain group information, display group information, and navigate to groups.

FIG. 6 is a block diagram illustrating a database 600, according to an embodiment, at the social networking server. The database 600 is shown to include social platform user profile information 602 that stores user profile information 604 for each user on the social networking server. The user profile information 604 may include information related to the user and, specifically, may include relationship information 606 and block information 608. The relationship information 606 may store a predetermined relationship between the user associated with the user profile information 604 and other users on the social networking server. For example, a first user may be designated a “friend,” “favorite friend,” or the like, with a second user, with the first user associated with the user profile information 604 and the respective designations associated with increasing levels of disclosure between the first user and second user. The block information 608 may store a configured preference of the user to block the addition of an item by other users to a watch list associated with the user. In some instances, one or more components of the network-based publisher 102 of FIG. 1 may be able to access specified portions of the database 600 via, for example, a programmatic interface. As such, data from the database may be mined.

In an example embodiment, social media communications (e.g., posts on a social media website, such as Facebook™ or distributed through Twitter™ feeds) may be mined for information that may be relevant to a determination of one or more items of an ecommerce system.

Referring back to FIG. 3, in an example embodiment, the reputation engine 310 may maintain a mapping to one or more social media services. The reputation engine 310 may access a database, such as database 126 of FIG. 1, to obtain login information for social media services, the login information corresponding to user accounts of the ecommerce service. Thus, when the reputation engine 310 calculates a reputation rating for a particular user, the reputation engine 310 may obtain login information for various social media services for which the particular user subscribes or otherwise is a member. The reputation engine 310 may also maintain a mapping for one or more social media services. The mapping may contain information indicating what type of information is to be extracted from each of the one or more social media services, and how such information should be extracted. The mapping may also indicate how the reputation engine 310 should use such information. For example, the mapping may indicate that, if the user has a Facebook account, the account should be accessed using the user's saved login information. The mapping may further indicate particular fields of the profile that should be accessed, such as a field indicating the number of friends the user has. The mapping may further indicate that the users' reputation rating should be boosted by 3 points if the user has more than 300 friends, by 2 points if the user has 200-300 friends, and by 1 point if the user has 100-200 friends.

In another example embodiment, the reputation engine 310 may dynamically alter a reputation rating for a user based on whether or not the user has a mutual friend with the user on the other side of the transaction. For example, a buyer who has a mutual friend in common with a seller may get a boost in his or her reputation rating when viewed by the seller, as opposed to a buyer with no such mutual friend in common who may not get such a boost.

FIG. 7 is a block diagram illustrating a system 700, in accordance with an example embodiment, of utilizing information from a social media service in an ecommerce service. Here, the reputation engine 310 accesses a database 126 that includes user login information for the user 702. The user 702 has an account with the ecommerce service 704 and an account with one or more social media services 706a, 706b, and 706n. The reputation engine 310 retrieves the login information for one or more of the social media services 706a, 706b, 706n from the database 126. The user 702 previously has provided this login information to the ecommerce service 704, which has linked it to the user's account. In an alternative example embodiment, the user 702 provides the log-in information in real time, in the form of a wizard or similar succession of screens that request the user log-in to the user's account at the one or more social media services 706a, 706b, 706n from inside the ecommerce service 704.

The reputation engine 310 also can access memory 708, which stores a mapping 710 between the ecommerce service 704 and the one or more social media services 706a, 706b, 706n. This mapping 710 may contain various fields 712a, 712b, 712c. One field 712a may provide information on how to access the corresponding social media service 706a, 706b, and 706n. Another field 712b may provide information on what information to retrieve from the corresponding social media service 706a, 706b, 706n (e.g., a listing of fields from which to retrieve the data and the corresponding locations of the fields in this listing). Another field 712c may provide information on how to use the information retrieved from the corresponding social media service 706a, 706b, 706n to affect the reputation rating (e.g., ranges of values that provide corresponding modifications to the reputation rating). The reputation engine 310 may then access one or more of the social media services 706a, 706b, 706n using the information from the mapping 710, and apply the retrieved information using the information from the mapping 710, thus altering the reputation rating of the user 702.

Either alternatively or in conjunction with such use of the reputation engine 310, information from social media services 706a, 706b and 706n may also be utilized to automatically form trading circles. Referring back to FIG. 3, the publication engine 302 may access a database, such as database 126 of FIG. 1, to obtain log-in information for social media services 706a, 706b, and 706n, the log-in information corresponding to user accounts of the ecommerce service 704. The publication engine 302 may then form one or more trading circles within the ecommerce service 704 based on information from the social media services 706a, 706b, and 706n. A trading circle may be a closed set of users whose ecommerce listings and/or activities are shared only with other users of the trading circle. For example, a trading circle formed for fans of a particular brand of remote control cars may have a circle automatically formed including users whose social media service interactions indicate that they are fans of the particular brand of remote control cars. This trading circle may allow, for example, these users to offer to sell their collectible cars of this particular brand only to the other users in the trading circle. The trading circle allows for a feeling of trust between the users and fosters an environment where users are more likely to part with goods having sentimental value or difficult-to-sell items.

As with the reputation rating, the information gleaned from social media services 706a, 706b, and 706n that can be used to form these trading circles may vary. In one example embodiment, information such as user interests listed in a user profile may be used (e.g., “I am a fan of the brand X remote control cars”). In another example embodiment, communications within the social media services 706a, 706b, and 706n may be monitored to determine user interest (e.g., the user may speak to friends a lot about brand X remote control cars).

As with the reputation aspects described above, a mapping 710 may be maintained by the publication engine 302. The mapping 710 may contain information indicating what type of information is to be extracted from each of the one or more social media services 706a, 706b, and 706n, and how such information should be extracted. The mapping 710 may also indicate how the publication engine 302 should use such information.

FIG. 8 is a block diagram illustrating a system 800, in accordance with an example embodiment, of utilizing information from a social media service 806a, 806b, 806n in an ecommerce service 804. Here, the publication engine 302 accesses a database 126 that includes user login information for the user 802. The user 802 has an account with the ecommerce service 804 but also has an account with one or more social media services 806a, 806b, 806n. The publication engine 302 retrieves the login information for one or more of the social media services 806a, 806b, 806n from the database 126. The user 802 previously has provided this login information to the ecommerce service 804, which has linked it to the user's account. In an alternative example embodiment, the user 802 provides the log-in information in real time, in the form of a wizard or similar succession of screens that request the user log-in to the user's account at the one or more social media services 806a, 806b, 806n from inside the ecommerce service 804.

The publication engine 302 also can access memory 808, which stores a mapping 810 between the ecommerce service 804 and the one or more social media services 806a, 806b, 806n. This mapping 810 may contain various fields 812a, 812b, 812c. One field, 812a, may provide information on how to access the corresponding social media service 806a, 806b, 806n. Another field, 812b, may provide information on what information to retrieve from the corresponding social media service 806a, 806b, 806n (e.g., a listing of fields from which to retrieve the data and the corresponding locations of the fields in this listing). Another field, 812c, may provide information on how to use the information retrieved from the corresponding social media service 806a, 806b, 806n to form trading circles (e.g., existing trading circles that be matched up with user interests, other users with similar interests from which to form a new trading circle). The publication engine 302 may then access one or more of the social media services 806a, 806b, 806n using the information from the mapping 810, and apply the retrieved information using the information from the mapping 810, thus forming a trading circle 814 containing the user 802 and other users 816a-816n.

In another example embodiment, items listed on the ecommerce service 804 (such as items listed for sale by a user) may be automatically shared among the other users 816a-816n in the trading circle 814. This sharing may occur in the one or more social media services 806a, 806b, 806n. For example, a user 802 who is a fan of brand X remote control cars, and who is a member of a brand X remote control car-trading circle by virtue of information from his Facebook™ profile, may post one of his collectible cars for sale. This listing may then be automatically posted on the user's Facebook™ page, but shared only with other members of the trading circle 814. This allows for custom sharing of item posting information based on trading circles.

In such instances, information about the trading circles 814 may be passed back to the one or more social media services 806a, 806b, 806n for their use, creating a symbiotic relationship between the ecommerce service 804 and the social media services 806a, 806b, 806n. The ecommerce service 804 may have its reputation ratings enhanced and develop trading circles based 814 on information from the social media services 806a, 806b, 806n, while the social media services 806a, 806b, 806n may receive trading circle and purchase information from the ecommerce site.

FIG. 9 is a flow diagram illustrating a method 900, in accordance with another example embodiment. At operation 902, login information for a social media service of a user of an ecommerce service may be retrieved. At operation 904, the login information may be used to retrieve information from the social media service. At 906, a reputation rating for the user in the ecommerce service may be altered based upon the retrieved information

FIG. 10 is a flow diagram illustrating a method 1000, in accordance with another example embodiment. At operation 1002, login information for a social media service of a user of an ecommerce service may be retrieved. At operation 1004, the login information may be used to retrieve information from the social media service. At 1006, a trading circle may be formed including the user as well as other users of the ecommerce service based on the information from the social media service.

FIG. 11 shows a diagrammatic representation of a machine in the example form of a computer system 1100 within which a set of instructions 1224 for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a personal digital assistant (PDA), a cellular telephone, a web appliance, a network router, switch or bridge, or any machine capable of executing a set of instructions 1224 (sequential or otherwise) that specify actions to be taken by that machine. Further, while only a single machine is illustrated, the term “machine” shall also be taken to include any collection of machines that individually or jointly execute a set (or multiple sets) of instructions 1224 to perform any one or more of the methodologies discussed herein.

The example computer system 1100 includes a processor 1102 (e.g., a central processing unit (CPU), a graphics processing unit (GPU), or both), a main memory 1104 and a static memory 1206, which communicate with each other via a bus 1108. The computer system 1100 may further include a video display unit 1110 (e.g., a liquid crystal display (LCD) or a cathode ray tube (CRT)). The computer system 1100 also includes an alphanumeric input device 1112 (e.g., a keyboard), a cursor control device 1114 (e.g., a mouse), a disk drive unit 1116, a signal generation device 1118 (e.g., a speaker), and a network interface device 1120.

The disk drive unit 1116 includes a computer-readable medium 1222 on which is stored one or more sets of instructions 1224 (e.g., software) embodying any one or more of the methodologies or functions described herein. The instructions 1224 may also reside, completely or at least partially, within the main memory 1104 and/or within the processor 1102 during execution thereof by the computer system 1100, with the main memory 1104 and the processor 1102 also constituting machine-readable media. The instructions 1224 may further be transmitted or received over a network 1126 via the network interface device 1120.

While the computer-readable medium 1222 is shown in an example embodiment to be a single medium, the term “machine-readable medium” should be taken to include a single medium or multiple media (e.g., a centralized or distributed database, and/or associated caches and servers) that store the one or more sets of instructions 1224. The term “machine-readable medium” shall also be taken to include any medium that is capable of storing, encoding, or carrying a set of instructions 1224 for execution by the machine and that cause the machine to perform any one or more of the methodologies described herein. The term “machine-readable medium” shall accordingly be taken to include, but not be limited to, solid-state memories, optical and magnetic media, and carrier wave signals.

Although the concepts have been described with reference to specific example embodiments, it will be evident that various modifications and changes may be made to these embodiments without departing from the broader spirit and scope of the concepts. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, subject matter lies in less than all features of a single disclosed embodiment. Thus the following claims are hereby incorporated into the Detailed Description, with each claim standing on its own as a separate embodiment.

What is claimed is:

1. A system, comprising:
a processor;
a publication engine configured to post descriptions of items for sale on an ecommerce service;
a database; and
a reputation engine configured to maintain reputation ratings for users of the ecommerce service, the reputation engine further configured to:
access login information for a social media service of a user of the ecommerce service from the database;
retrieve information from the social media service using the log-in information; and
alter a reputation rating for the user in the ecommerce service based on the retrieved information.

2. The system of claim 1, further comprising a memory storing a mapping between the ecommerce service and the social media service, wherein the mapping indicates one or more fields of data to retrieve from the social media service and an indication of how to alter the reputation rating based on data in the one or more fields of data.

3. The system of claim 1, wherein the information from the social media service includes an indication that there is a mutual friend between the user and another user of the ecommerce service.

4. The system of claim 3, wherein the reputation rating for the user is altered only with respect to the other user.

5. The system of claim 2, wherein the mapping further contains a mapping between the ecommerce service and a second social media service, and wherein the reputation engine is further configured to:
access login information for the second social media service for the user from the database;
retrieve information from the second social media service using the log-in information; and
further alter the reputation rating for the user in the ecommerce service based on the retrieved information from the second social media service.

6. The system of claim 1, wherein the publication engine is configured to form a trading circle including the user and other users of the ecommerce service based on the retrieved information.

7. The system of claim 1, wherein the publication engine is further configured to share information about the trading circle with the social media service.

8. A method, comprising:
receiving login information for a social media service of a user of an ecommerce service;
retrieving information from the social media service using the log-in information; and
altering a reputation rating for the user in the ecommerce service based on the retrieved information.

9. The method of claim 8, wherein the information from the social media service includes a number of friends indicated for the user in the social media service.

10. The method of claim 8, wherein the information from the social media service includes an indication that there is a mutual friend between the user and another user of the ecommerce service.

11. The method of claim 10, wherein the other user of the ecommerce service is a seller of an item the user is interested in purchasing.

12. The method of claim 10, wherein the other user of the ecommerce service is a potential buyer of an item the user is selling.

13. The method of claim 10, wherein the reputation rating for the user is altered only with respect to the other user.

14. The method of claim 8, further comprising:
receiving second login information from a second social media service of the user;
retrieving information from the second social media service using the second log-in information; and
further altering the reputation rating based on the retrieved information from the second social media service.

15. A method comprising:
receiving log-in information for a social media service of a user of an ecommerce service;
retrieving information from the social media service using the log-in information; and
forming a trading circle including the user as well as other users of the ecommerce service based on the information from the social media service.

16. The method of claim 15, wherein the information from the social media service includes interest information from a user profile.

17. The method of claim 15, wherein the information from the social media service includes interest information derived from communications within the social media service.

18. The method of claim 15, wherein the information from the social media service includes communications from within the social media service.

19. The method of claim 15, further comprising automatically sharing items listed for sale on the ecommerce site by the user with the other users of the ecommerce service in the trading circle.

20. The method of claim 15, further comprising sharing information about the trading circle with the social media service.
